(19) United States
(12) Patent Application Publication
(10) Pub. No.: US 2012/0036154 A1
(43) Pub. Date: Feb. 9, 2012

(54) DYNAMIC CONTENT LINKED TO CONTACT IDENTIFIERS

(75) Inventor: Asha Vellaikal, Menlo Park, CA (US)

(73) Assignee: France Telecom, Paris (FR)

(21) Appl. No.: 13/262,312

(22) PCT Filed: Mar. 30, 2010
(86) PCT No.: PCT/IB2010/001267

§ 371 Date: Oct. 27, 2011

Related U.S. Application Data
(60) Provisional application No. 61/165,404, filed on Mar. 31, 2009.

(51) Int. Cl. G06F 17/30

(52) U.S. Cl. 707/770; 707/E17.014

(57) ABSTRACT

A system, method, device and interface for accessing dynamic contact data. The system may include associating a telephone number with one or more uniform resource locators (URLs) identifying corresponding data sources, submitting a query in a form of a telephone number, retrieving the associated one or more URLs, retrieving data from the data sources corresponding to the one or more URLs, and rendering the retrieved data. Associating may be performed by a publisher interacting with a service platform server. The one or more of submitting, retrieving and rendering may be performed by a customer interacting with a service platform server.

### FIELD OF THE PRESENT SYSTEM

The present system relates to at least one of a method, user interface and apparatus for providing seamless access and delivery of dynamic contact data.

### BACKGROUND OF THE PRESENT SYSTEM

Many consumers and businesses produce dynamic information. For example, past systems provide services such as status messages on twitter, facebook, blog posts, media sharing on social media sites such as flick, facebook, etc. Other systems, such as Netflix provide user's an ability to comments on movies they are watching/planning to watch, as well as bookmarks for content, etc.

For businesses, the information may be many fold including calendars for service appointments (e.g. doctors, salons), promotions/coupons/deals, news press releases, etc.

Systems are provided that may aggregate services that are available over the Internet, such as services supported by a lifestream aggregator such as Friendfeed (available at friendfeed.com/settings/services), show some of the most popular activity streams for a consumer space.

Typically, these dynamic updates are published via formats such as RSS and ATOM. Over the course of the last few years, RSS/ATOM formats have found a lot of usage in the Web2.0 space. On the web, it is common for each of the above updates to be available in RSS/ATOM format or available through access to a given Uniform Resource Locator (URL).

However, for contacts between people, unlike accessing resources on the web where it is common to go to a URL or add an RSS stream, the primary unique identifier for a person on a mobile phone is typically at least one phone number for the person. For each contact on the phone, adding at least one phone number is almost mandatory. The more advanced smartphones today support inclusion of more details such as email addresses, websites, IM handles and so on. But the most important communication handle on the mobile phone still remains a contact phone number.

None of these prior systems provides a system, method, user interface and device to provide seamless access and delivery of dynamic contact data.

### SUMMARY OF THE PRESENT SYSTEM

It is an object of the present system to overcome disadvantages and/or make improvements in the prior art.

The present system includes a system, method, device and interface for accessing dynamic contact data. The system may include associating a telephone number with one or more uniform resource locators (URLs) identifying corresponding data sources, submitting a query in a form of a telephone number, retrieving the associated one or more URLs, retrieving data from the data sources corresponding to the one or more URLs, and rendering the retrieved data. In one embodiment of the present system, associating may be performed by a publisher interacting with a service platform server. The one or more of submitting, retrieving and rendering may be performed by a customer interacting with a service platform server.

In one embodiment of the present system, submitting the query may include querying a contact list and retrieving one or more telephone numbers from the contact list, wherein the retrieved one or more telephone numbers is the submitted query. In another embodiment of the present system, submitting may include receiving a telephone call on a user device and retrieving a caller id associated with the telephone call, wherein the retrieved caller id is the submitted query.

The submitting the query and retrieving may be performed periodically without further user intervention. The submitting the query and retrieving may be performed in response to starting an application on a user device without further user intervention. An additional URL identifying an additional data source may be associated with the telephone number. During associating, the telephone number may be verified as a telephone number of a user performing the act of associating. Further, associating may include verifying that the one or more URLs correspond to a valid data source. In accordance with an embodiment of the present system, at least one of the one or more URLs may correspond to an aggregator data source.

### BRIEF DESCRIPTION OF THE DRAWINGS

The invention is explained in further detail, and by way of example, with reference to the accompanying drawings wherein:

FIG. 1 is a high-level block diagram that illustrates a computing system in accordance with an embodiment of the present system;

FIG. 2 illustrates an exemplary contact list data structure in accordance with an embodiment of the present system;

FIG. 3 illustrates different associations that may be provided between contacts and dynamic data sources in accordance with embodiments of the present system;

FIG. 4 shows a flow diagram of a registration process in accordance with an embodiment of the present system;

FIG. 5 shows a graphical user interface that may be implemented in accordance with an embodiment of the present system;

FIG. 6 shows a flow diagram of a method for accessing dynamic contact data in accordance with an embodiment of the present system;

FIG. 7 shows a graphical user interface that may be implemented in accordance with an embodiment of the present system; and

FIG. 8 shows a system in accordance with an embodiment of the present system.

### DETAILED DESCRIPTION OF THE PRESENT SYSTEM

The following are descriptions of illustrative embodiments that when taken in conjunction with the following drawings will demonstrate the above noted features and advantages, as well as further ones. In the following description, for purposes of explanation rather than limitation, illustrative details are set forth such as architecture, interfaces, techniques, element attributes, etc. However, it will be apparent to those of ordinary skill in the art that other embodiments that depart from these details would still be understood to be within the scope of the appended claims. Moreover, for the purpose of clarity, detailed descriptions of well known devices, circuits, tools, techniques and methods are omitted so as not to obscure the description of the present system. It should be expressly understood that the drawings are included for illustrative purposes and do not represent the scope of the present system. In the accompanying drawings, like reference numbers in different drawings may designate similar elements.

For purposes of simplifying a description of the present system, the terms “operatively coupled”, “coupled” and formatives thereof as utilized herein refer to a connection between devices and/or portions thereof that enables operation in accordance with the present system. For example, an operative coupling may include one or more of a wired connection and/or a wireless connection between two or more devices that enables a one and/or two-way communication path between the devices and/or portions thereof. For example, an operative coupling may include a wired and/or wireless coupling to enable communication between a content server, such as between a dynamic contact data service platform and client device. A further operative coupling, in accordance with the present system may include one or more couplings between the service platform, a data server and a client device, in accordance with an embodiment of the present system.

The term rendering and formatives thereof as utilized herein refer to providing content, such as digital media, such that it may be perceived by at least one user sense, such as a sense of sight and/or a sense of hearing. For example, the present system may render a user interface on a display device so that it may be seen and interacted with by a user. Further, the present system may render data from a data service, render unique user identifiers, such as telephone numbers, render one or more user interfaces, etc. To simplify the following discussion, the term data, data services, aggregated data and formatives thereof will be utilized and should be understood to include audio data, visual data, audio visual data, textual data and/or other data types, unless a particular data type is specifically intended, as may be readily appreciated by the context of the stated data herein.

The term publisher is utilized herein and is intended to include a user (e.g., an individual or a business) that publishes (e.g., original content) or makes available some data and/or dynamic data (e.g., data streams, such as provided by Facebook) which may be linked to through a phone number in accordance with the present system. A consumer in accordance with the present system may be an individual who sees the dynamic updates of the publishers on his/her client (e.g., a smartphone).

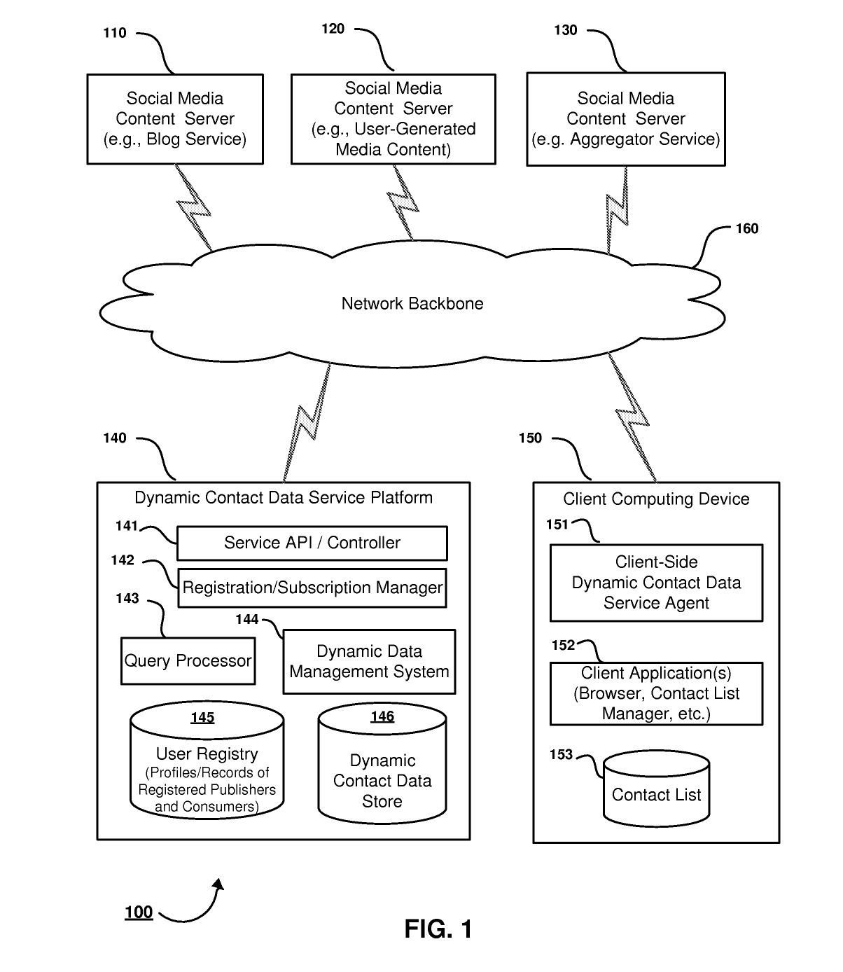

FIG. 1 shows a high-level block diagram of a computing system according to an exemplary embodiment of the present system that supports seamless access and delivery of dynamic contact data. In general, the computing system 100 comprises a plurality of server computing nodes 110, 120, 130, 140 and a client computing node 150, which are operatively coupled for communication over a backbone of one or more communication networks 160.

The server computing nodes 110, 120, 130 may be network server machines of different service providers that that execute a server application to support content delivery (media content, news, data archival, etc.) or support e-transactions, etc.

For instance, the content server 120 may provide a web-based service that enables users to publish/share user-generated content (e.g., YOUTUBE.COM). The content server 130 may host a lifestreaming platform, such as Facebook, that provides an online record of a person's daily activities, such as through a direct video feed or by aggregating a person's online content such as blog posts, social network updates, online photos, etc.

The network backbone 160 may comprise be a local or wide area network, a corporate intranet, a wireless network (e.g., Bluetooth wireless network), a global communications network (e.g., the Internet), etc., or any combination thereof. In accordance with the present system, the network backbone 160 provides an operable coupling between the plurality of server computing nodes 110, 120, 130, 140 and the client device 150.

The client device 150 may be any type of portable/mobile computing device such as a laptop computer, portable handheld device (e.g., PDS, mobile phone, smartphone, etc.) which executes one or more software applications for operation in accordance with the present system. For example, the client device 150 may include a client-side dynamic contact data service agent 151 that is adapted for use with the server computing nodes including the server computing node 140 in accordance with the present system, which operates as a dynamic contact data service platform, such as the server computing node 140, hereinafter termed the service platform 140. In accordance with the present system, the client device 150 is operable to provide communication with the service platform 140 to send information to and/or receive information from the service platform 140.

The service platform 140 comprises functional modules including, for example, an API (application programming interface)/controller module 141, a registration manager module 142, a query processor module 143, a dynamic data management system 144, a user registry 145 and a dynamic contact data store 146 which are operably coupled together. The service platform 140 provides an application framework for enabling a user's (e.g., consumer) client device 150 to automatically acquire data, such as dynamic data, associated with another users telephone number. The service platform 140 also provides an application framework for enabling a user's client device 150 to register with the service platform 150 wherein the registration process may include verification of the users telephone number as well as an identification of data sources for association with the users telephone number.

The API module 141 provides a service interface that allows a client device to access and/or invoke services of the service platform 140. The API module 141 may also provide operability for advertising, locating, discovering, and registering hardware device services through standard web service interfaces and protocols as may be readily appreciated by a person of ordinary skill in the art. In operation, the API module 141 controls invocation and process flow execution of application logic for accessing and being accessed by data and/or services of one or more devices, such as the server computing nodes 110, 120, 130, and/or the client device 150, through the network backbone 160 in accordance with the present system. The API module 141 may include logic to drive the service invocation behavior of the service platform 140 and control the runtime logic flow for operation in accordance with the present system.

For example, the API module 141 may provide access to data and/or data services through operation of the dynamic data management system 144 and access to the user registry 145, the dynamic contact data store 146, and the server computing nodes 110, 120, 130. The user registry 145 provides for storage of profiles/records of registered users and publishers of data and data services. The dynamic contact data store 146 may provide for storage of dynamic data linking information available from the server computing nodes 110, 120, 130, albeit associated with contact information of user to facilitate retrieval of the data form the service platform 140. However, in another embodiment, the dynamic contact data store 146 may be deleted althogether an associated linking information may be provided by access to the user registry 145.

The API module 141 may also provide for registration of users and registration of publishers of data and data services through operation of the registration/subscription manager 142. An identification of publishers, (registered) data and/or data services may be stored in the user registry as well as an identification of registered users and/or services including profiles/records of registered publishers and users. For example, the user registry 145 may provide for registration and an association of users, publishers, data and data services with a contact phone number of the user through operation of the registration/subscription manager 142.

The query processor 143 may provide for querying of one or more of the user registry 145 and/or the dynamic contact data store 146 with or without interaction with the dynamic data management system 144.

The client device 150 may be any type of user device including a portable/mobile computing device such as a laptop computer, portable handheld device (e.g., PDS, mobile phone, smartphone, etc.), which executes one or more software applications for operation in accordance with the present system. The client device 150 may include a client-side dynamic contact data service agent 151, one or more client applications 152 and a data storage 153. The service agent 151 is adapted for providing user interaction with the server computing nodes including the server computing node 140 in accordance with the present system. The service agent 151 operates on the client device 150 to provide a dynamic contact data service platform for a user in accordance with the present system.

In accordance with the present system, the client device 150 is operable though use of the service agent 151 to provide communication with the service platform 140 to send information to and/or receive information from the service platform 140. As is typical of client devices, the client device 150 may include the one or more client applications 152, such as a browser application, a contact list manager, a datebook application, etc. For example, the browser application may provide the user access to data and data services, such as those available by accessing the server computing nodes 110, 120, 130 independent of service agent 151 as may be readily appreciated by a person of ordinary skill in the art. However, in accordance with the present system, the browser may operate for a providing access to the service platform 140 through operation of the service agent 151, such as wherein the service agent 151 adds functions to the browser particular for operation in accordance with the present system. Similarly, one or more of a contact list manager, datebooks, etc., may operate as provided in prior system for keeping contacts (e.g., names), contact information (e.g., phone numbers, email addresses, addresses, etc of contacts), appointments, etc., of the user. In this regard, the client applications 152 may operate local to the client device 150 utilizing only data that is stored in the data storage 153 and/or may operate by accessing data stored on a remote server, such as one or more of the server computing nodes 110, 120, 130, 140. For example, a contact list manager may operate through accessing a server hosted data service, such as Google Sync to enable synchronization between contacts and/or calendar entries through use of the server hosted data service.

However, significantly, the service agent 151 may operate through use of the client applications 152 and/or the data storage 153 to provide seamless access and delivery of dynamic contact data. For example, the data storage 153 may include a contact list including contact information on users with which the user of the client device 150 is associated (e.g., friends, family, business clients, service providers, etc.)

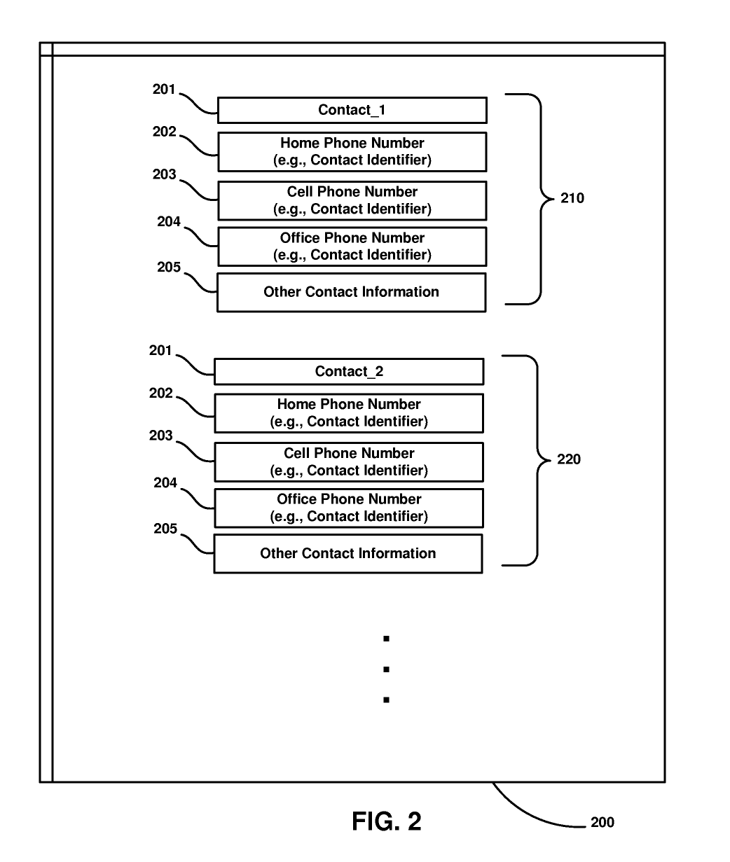

FIG. 2 illustrates an exemplary contact list data structure in accordance with an embodiment of the present system. Illustratively, the contact list includes one or more contacts 210, 220 that may be stored on a client computing device 200. Each of the contacts 210, 220 may include information for the one or more contacts including a plurality of information fields. The plurality of information fields may include one or more of an identifier 201, a home phone number 202, a cell phone number 203, an office phone number 204, as well as other contact information, such as an email address, etc., that is associated with the contact. The identifier 201 serves to identify each contact to the user, such as a given user, as may be readily appreciated by a person of ordinary skill in the art. In accordance with the present system, one or more parts of the contact information, such as telephone numbers of a given user, etc., may be utilized by another user as a link to data and/or data services, such as a user's dynamic data as described further herein.

In accordance with the present system, one or more applications running one the client device (e.g., a mobile phone, cellular phone, etc.) and communicate with the service platform 140 through the network backbone, such as a network cloud, Internet connection, etc. In accordance with the present system, there may be many different client devices with differing functionality that each may operate though access to the service platform 140. Regardless of the client device, in accordance with the present system, a link is provided between a contact identifier, such as may be provided by a telephone entry in a contact list manager application present on a client device and dynamic data, such as provided by one or more of the server computing nodes 110, 120, 130 through operation of the service platform 140.

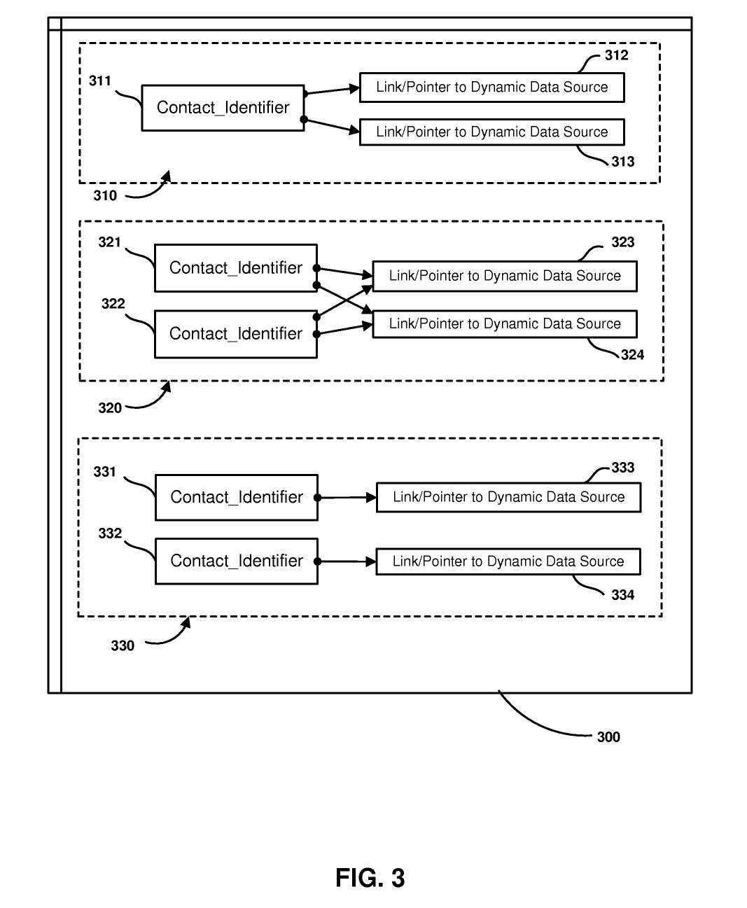

FIG. 3 illustrates different associations that may be provided between contacts and dynamic data sources through operation of the service platform 140 in accordance with embodiments of the present system. Typically, the association is provided during a registration/update process of a user wherein a user, for example through use of a client service agent, accesses the service platform for registration and/or updating of user information including the users contact identifier and associated data sources as for example may be provided in a data store (e.g., computer storage device) of the service platform, such as the user registry 145 shown in FIG. 1.

Illustratively, a data store 300 may include one or more associations 310, 320, 330. Each of the associations 310, 320, 330 provides a contact identifier, such as contact identifiers 311, 321, 322, 331, 332, that is associated with a link/pointer to a data source, such as link/pointers 312, 313, 323, 324, 333, 334 in accordance with the present system. For example, the contact identifying 311 is shown linked to two different data sources. A user, that provides the contact identifier 311, for example, from the users contact management application resident on the client device and/or on a service hosting a contact application, will be provided with each of the dynamic data sources 312, 313. A user, that provides either of the contact identifiers 321, 322, will be provided with each of the dynamic data sources 323, 324. A user, that provides the contact identifier 331, will be provided with the dynamic data source 333 while a user, that provides the contact identifier 332, will be provided with the dynamic data source 334 even though each of the contact identifier 331 and the contact identifier 332 are associated with a single given association.

In accordance with the present system, there are many advantages to linking a contact identifier, such as a phone number, with a dynamic data source. For example, for the publisher, linking their phone number(s) to their data, such as activity streams (e.g., Facebook, Twitter, etc.) enables any consumers who have the publishers phone number to get to know what is being published by the publisher without a need to individually access websites, etc., where the publisher may publish.

For example, lets say that Asha is a friend of Steve. Asha has Steve's phone number in her phone addressbook application. Steve regularly updates his status on Twitter and Facebook and posts his latest photos to Flickr. Steve wants to make this information available to all his friends. In prior systems, Steve has to either provide all the information to access each of the information sources to each of his friends or others that he wishes to provide access to or he may link these sources through a data source (e.g., lifestream) aggregator such as Friendfeed, yet he still must provide linking information to each user to enable access to the aggregated data source.

However, in accordance with the present system, Steve may pull in all his information to create a single feed for his lifestream data (or keep the data sources separate) and need only provide the one or more links, such as one or more of the links shown in FIG. 3, on the service platform. In this way, Steve links together his phone number to his data sources. In operation, the dynamic data management system creates a link between Steve's phone number and his data, which may include aggregated and/or individual data sources.

Now, Asha has Steve's phone number in her addressbook application. Lets assume that there is an application in accordance with the present system (e.g., the service agent 151) that is running on Asha's phone. In accordance with an embodiment of the present system, the application accesses Asha's addressbook phone numbers through operation of a contact list manager and/or directly through accessing the data storage 153. The application may then contact the service platform 140 to get the corresponding data URL's and access information if required, such as a lifestream URL. Through use of the URL (and access information, such as password, username, etc., if required), the application may then retrieve Steve's latest publications (e.g., data, data streams, etc.) and other users from Asha's addressbook (if desired). Lastly, through use of the service agent, the data may be rendered on the mobile phone screen within a user interface provided by the service agent and/or provided by a browser application.

Significantly, in accordance with the present system, for a given consumer/user, he/she does not have to enter individual or aggregate data/RSS stream for every given publisher in their contact list. In accordance with the present system, the original publisher of the phone number enters the data and connects/links their data sources, RSS streams (e.g., publication sources) via service in accordance with the present system. Thus, updates to data and data sources may happen without the consumer/user having to do anything, since the publishers phone numbers are available for most of their contacts in the phone addressbook.

It should be pointed out that a service platform in accordance with the present system need not be tied to any one specific publishing source, such as a given social media application. For example, a given publisher may publish at any publishing source desired, such as Facebook, Twitter, Flickr, etc. Thereafter, the publisher may to an aggregation service such as FriendFeed and generate a single update stream that includes all of his/her updates. In this case, the publisher need only associate their telephone number with a single data source, namely, the aggregation service. In a second option, the publisher may register with the service platform in accordance with the present system, multiple separate and/or aggregated data sources (e.g., data streams) with the service platform and associate a given phone number. In this case, the consumer/users will have to retrieve the updates for each data service separately.

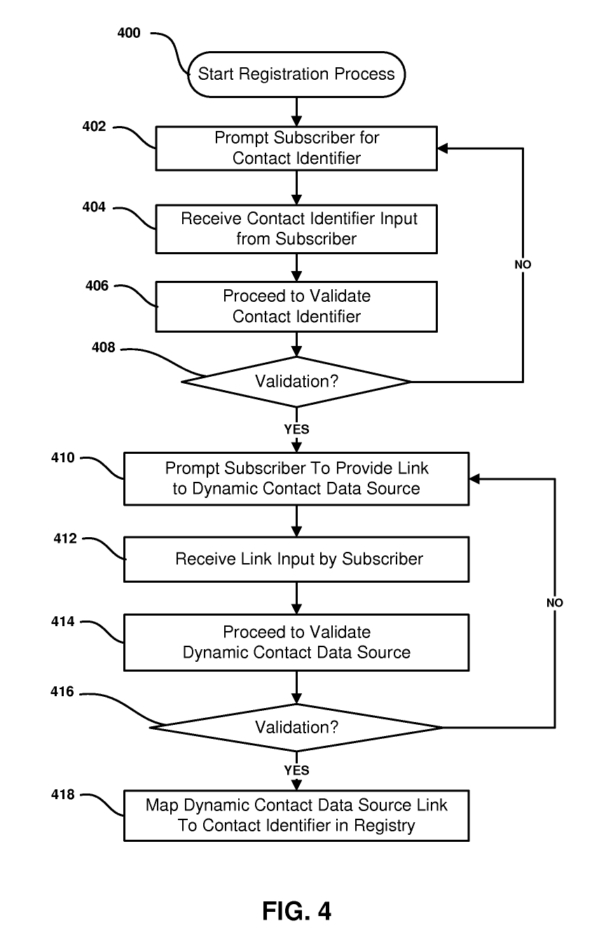

FIG. 4 shows a flow diagram of a registration process according to an exemplary embodiment in which a subscriber can register with a service in accordance with the present system and thereby, enable their published data, such as activity streams or URL's associated with the published data, to be discovered by simply referencing a phone number. In particular, FIG. 4 illustrates one exemplary embodiment of a method that may be implemented by the registration manager module 142 of the dynamic contact data service platform 140 as illustratively depicted in FIG. 1. Particularly, the publisher/subscriber through operation of the present system, registers a unique contact identifier that maps to one or more dynamic data sources of the publisher through the operation illustrated in the flowchart of the registration process.

In operation, the subscriber (publisher) accesses the service platform to commence a registration process during act 400 using any suitable method/application such as through use of a browser application running on the client device. This registration process can happen either through a well-defined website (as illustratively described below) or through any other sort of interaction. For example, in an example below, the user may utilize a web browser to access a specific website hosted by a server in accordance with the present system and may systematically go through a process to link a contact identifier (e.g., phone number) with one or more data sources. It should be noted that since the process of registering is so simple, the interaction may completely happen through a mobile device, such as a cellular phone as well as on any other suitable client device. For example, the entire steps above may be accomplished via SMS interactions.

The system prompts the user/publisher/subscriber to provide a unique contact identifier during act 402. For instance, in one exemplary embodiment, the contact identifier may be a phone number, email address or other personal identification information that uniquely identifies a particular entity or terminal.

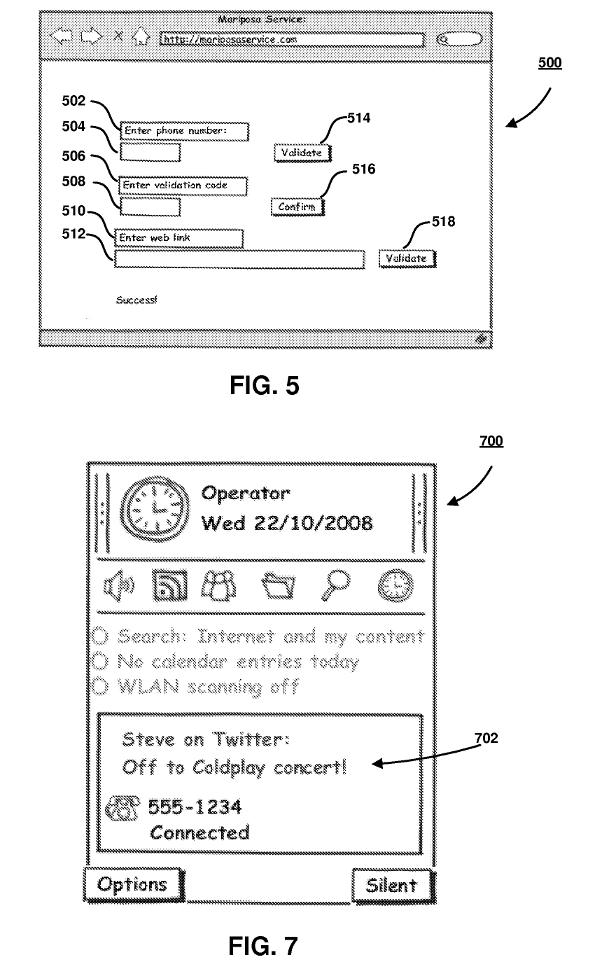

After the system receives the contact identifier input from the user during act 404, a validation process is commenced to validate the contact identifier during 406. For instance, as depicted in FIG. 5, the user may utilize a user interface 500 to enter a unique contact identifier, such as a phone number into an input field 504. The user may thereafter initiate the validation process by clicking on a validate button 506. There are multiple ways to validate a phone number. For mobile phones, a random number may be sent to the user, such as via SMS. Thereafter, the user may access a server platform in accordance with the present system to enter as a portion of the validation process to validate the phone number. In another embodiment in accordance with the present system, a similar process may be utilized through use of a phone call where a random number is spoken and the user again enters this number on the validation form. The purpose of validating the unique contact identifier is to confirm that the unique contact identifier provided by the user actually belongs to the user submitting the unique contact identifier, such as a phone number. Should the unique contact identifier not be verified by the user, the linking of the unique contact identifier to a data source will not be allowed.

After the phone number is verified by the system, the next process involves linking an activity stream with the phone number during act 410. In this way in accordance with the present system, the server allows the user an ability to input one or more URL link to data and/or one or more data sources (e.g., a RSS/ATOM link) during act 410. Again the system validates that the URL exists or that the URL (e.g., RSS/ATOM link) is a valid format and link during act 414. Should the link be determined to not be valid during act 416, the system may again prompt the user to enter a valid link. In accordance with an embodiment of the present system, the system may retrieve data corresponding to the link and display the retrieved data to provide the user an opportunity to confirm that a desired link is provided. Once the link/RSS is validated, the system will provide a mapping between the provided unique contact identifier(s) (e.g., phone number, email address, etc.) and the one or more data sources during act 418. Thereafter, the system in accordance with the present system is ready to accept queries on this phone number.

As may be readily appreciated, at any point in time, The service platform in accordance with the present system may have unique contact identifiers (e.g., multiple phone numbers) and corresponding links indexed. The purpose of the present system is to support a query from a consumer/user. Particularly, in response to a query from a consumer that provides a unique contact identifier, such as a given a phone number, the present system responds by providing the corresponding URL/RSS feed(s) to the client device.

Note that the present system may support one or multiple phone numbers in a single query such as shown with reference to FIG. 3. In accordance with the present system, a response may be an indication that no info is available for the provided unique contact identifier or a list of URL/RSS links that may be utilized by one or more or the server platform and/or the client device for providing the consumer/user the data that corresponds to the URL/RSS links. As further shown in FIG. 3, the system may support multiple links for a unique contact identifier (e.g., a single phone number).

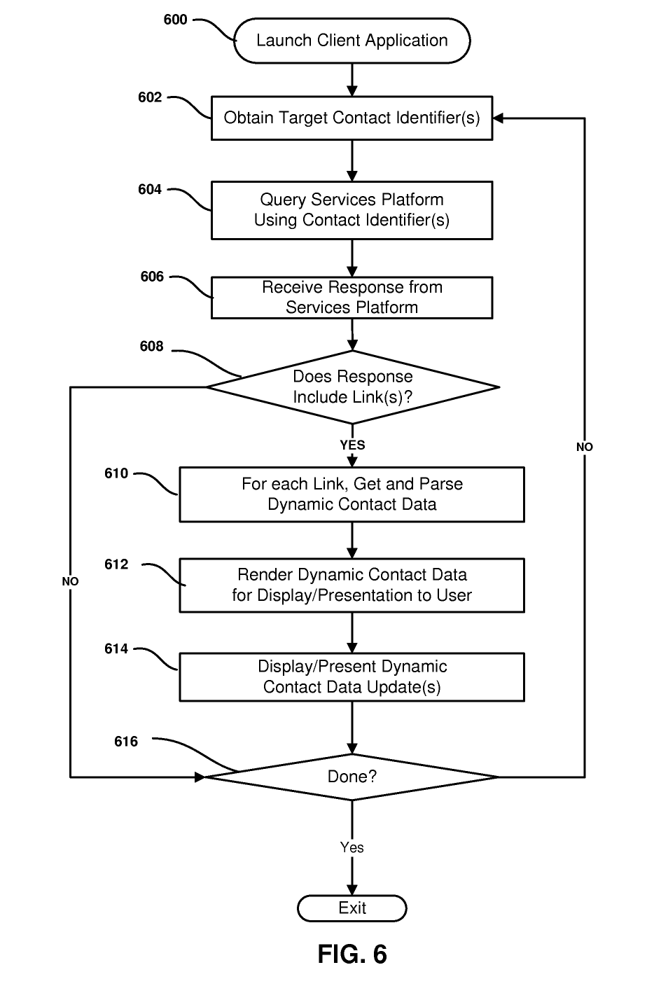

FIG. 6 shows a flow diagram of method for accessing dynamic contact data according to an exemplary embodiment of the present system. In particular, FIG. 6 is an exemplary mode of operation of the client computing device of FIG. 1 in which the client device queries the service platform.

An initial act includes initializing and launching the client-side service agent that runs on the client computing device during act 600 for communicating with a dynamic contact data service provider, such as a service provider hosting the service platform in accordance with the present system. Depending on the particular implementation, the client service agent may be initialized and remain running while the client device is turned on and thereby, the client service agent may operate continuously (or periodically) in the background while the client device is on. In other embodiments, the client service agent may be started on demand upon user command or upon a certain event and then may terminate after performing a certain function, such as a query and data retrieval.

The client service agent may obtain one or more unique contact identifiers for one or more contacts, for example from a contact list stored on the client computing device during 602. Thereafter, the one or more unique contact identifiers is provided to the service platform in a form of a query during act 604. A response is received at the client device from the service platform during act 606.

Thereafter, during act 608, the client service agent may confirm whether the response includes link(s). In a case wherein the response does not include links, the process may conclude operation during act 616 or may proceed to receive a further unique identifier. For example, in one embodiment of the present system, the client service agent may retrieve a plurality of unique contact identifiers from the consumers contact list. Each of the unique contact identifiers may be provided in a form a single query or one or more of the unique contact identifiers may be provided at a time.

It is to be understood that the method of FIG. 6 is provided to facilitate an understanding of an operation in accordance with the present system. However, it should be understood that this operation is not intended to exclude other operations in accordance with the present system.

The following are examples of client interactions in accordance with embodiments of the present system. Note that the details provided may vary in accordance with the present system depending on the nature of the client service application and client device.

In one embodiment of the present system, a consumer/user may be provided with friends data updates within a portion of the user interface provided on the client device, such as a home screen 700 as shown in FIG. 7. In this scenario, there may be provided a client service application on a client device, such as a mobile (e.g., cellular) client device that reads phone numbers from the user's contact list and then queries service platform server to identify data sources associated with the phone numbers. The data sources may be aggregated together and rendered within a portion 702 of the home screen such that dynamic updates are provided on the phone home screen.

Similar interfaces may be provided by a client device having a touch sensitive screen that is operated on by an input device such as a finger of a user or other input device such as a stylus. In this environment, a cursor may or may not be provided since location of selection is directly determined by the location of interaction with the touch sensitive screen. Although the GUI utilized for supporting touch sensitive inputs may be somewhat different than a GUI that is utilized for supporting, for example, a computer mouse input, however, for purposes of the present system, the operation is similar. Accordingly, for purposes of simplifying the foregoing description, the interaction discussed is intended to apply to an user interface that may be suitably applied.

In accordance with an embodiment of the present system, the service agent application may start (or wake up according to pre-programmed intervals). In this embodiment, the client service agent application may read one or more phone numbers in the consumer's contact list. For example, in one embodiment, the service agent application may read all the contacts in a contact list or may only read selected contacts (e.g., each particularly indicated by the consumer and/or as provided by a group indication, such as a friends list). The service agent application thereafter queries the server platform server with the read phone numbers, and retrieves the mapped links, such as from the dynamic contact data store (see, FIG. 1). For each link retrieved, the service agent application retrieves the updated data and may render the retrieved data on the client device, such as displaying the retrieved data on home screen.

In accordance with a further embodiment of the present system, a special contact list manager/addressbook may be provided on the client device which provides a “Get status” button. A sequence of events in accordance with an embodiment of the present system is provided as follows: First, a customer/user may navigate to a certain contact in an addressbook application provided on the client device. After the user selects a given contact, multiple choices may be provide by the addressbook application including call, send message, video call, etc. In addition in accordance with an embodiment of the present system, there may be provided a “get updates” selection item, such as a radio button. The user may select “get updates” wherein after, the enhanced addressbook application queries a service platform server in accordance with the present system with one or more phone numbers available for that particular contact, such as all the available phone numbers. Thereafter, as previously discussed, the service agent application may retrieve the links mapped to the one or more phone numbers and for each link retrieved, the service agent application may retrieve the updated data and may render the retrieved data on the client device, such as displaying the retrieved data on the home screen.

In accordance with a further embodiment of the present system, a user may automatically get the latest updates of the current caller/publisher just before (e.g., when the call has come through and has not yet been answered), during or after a telephone call is established. A illustrative sequence may be provided as follows: For example, for a user that is currently on a phone call, the user device, such as a phone may have a service agent application that can retrieve the phone number of a current caller, such as though use of a caller id as may be readily appreciated. In this embodiment, the service agent application may use the caller id to query the service platform server, retrieve corresponding links and thereafter, for each link, get and display updated data.

As may be readily appreciated, the service agent application may also provide for rendering of retrieved data within a particular user interface provided by the service agent application. For example, in accordance with an embodiment of the present system, a user interface may be provided for retrieving and rendering dynamic content. In a further embodiment, the client device may be enabled to provide data back to one or more of the server computing nodes 110, 120, 130, 140 as shown in FIG. 1. For example, in accordance with an embodiment, the customer through operation of the client device may provide an update to a dynamic data source. As an example, a physician may publish a calendar of available office hours to a data server and through interaction with the service platform server in accordance with the present system, may map the calendar to his office telephone number. A customer wishing to make an appointment with the physician may enter a service agent application running on their client device and navigate over to a listing of the physicians contact information. The customer may select a get data element within the user interface of the service agent application wherein after, the physician's calendar is retrieved and rendered similar as other data sources described above. However, in accordance with this embodiment, the service agent application may also provide a make appointment interaction element wherein an available appointment time may be selected by the customer. The selection may trigger a transmittal of appointment information to the data server of the physician through operation of which, the appointment may be confirmed or rejected. In any event, a further update on the client device of the physician's data could confirm whether the appointment was accepted or rejected or a confirmation/rejection may be forwarded separately to the client device in accordance with the present system.

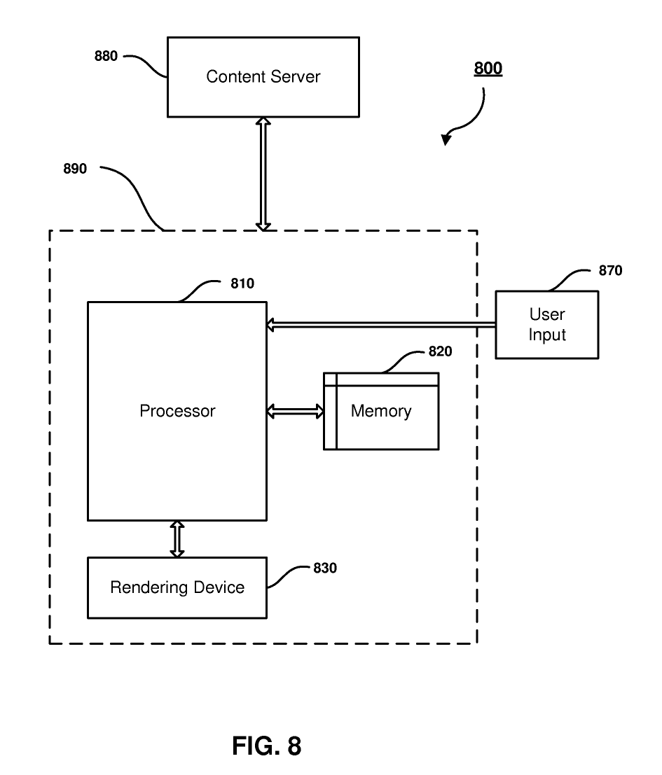

FIG. 8 shows a system 800 in accordance with an embodiment of the present system. The system 800 includes a user device 890 that has a processor 810 operationally coupled to a memory 820, a rendering device 830, such as one or more of a display, speaker, etc., a user input device 870 and a content server 880, such as a service platform server (e.g., server 140 shown in FIG. 1), one or more server computing nodes, such as the server computing nodes 110, 120, 130 (shown in FIG. 1), etc., operationally coupled to the user device 890. The memory 820 may be any type of device for storing application data as well as other data, such as unique contact identifiers, etc. The application data and other data are received by the processor 810 for configuring the processor 810 to perform operation acts in accordance with the present system. The operation acts include controlling at least one of the rendering device 830 to render one or more user interfaces described herein. The user input 870 may include a keyboard, mouse, trackball or other devices, including touch sensitive displays, which may be stand alone or be a part of a system, such as part of a personal computer, personal digital assistant, mobile phone, converged device, or other rendering device for communicating with the processor 810 via any type of link, such as a wired or wireless link. The user input device 870 is operable for interacting with the processor 810 including interaction within a paradigm of a GUI and/or other elements of the present system, such as to enable web browsing, registration, querying of the service platform server, retrieval of mapped URL's, retrieval of corresponding data, etc., as may be readily appreciated by a person of ordinary skill in the art.

In accordance with an embodiment of the present system, the rendering device 830 may operate as a touch sensitive display for communicating with the processors 810 (e.g., providing selection of a web browser, a Uniform Resource Locator (URL), portions of web pages, etc.) and thereby, the rendering device 830 may also operate as a user input device. In this way, a user may interact with the processor 810 including interaction within a paradigm of a UI, such as to support content selection, input of reaction indications, comments, etc. Clearly the user device 890, the processor 810, memory 820, rendering device 830 and/or user input device 870 may all or partly be portions of a computer system or other device, and/or be embedded in a portable device, such as a mobile telephone, personal computer (PC), personal digital assistant (PDA), converged device such as a smart telephone, etc.

The methods of the present system are particularly suited to be carried out by a computer software program, such program containing modules corresponding to one or more of the individual steps or acts described and/or envisioned by the present system. Such program may of course be embodied in a computer-readable medium, such as an integrated chip, a peripheral device or memory, such as the memory 820 or other memory coupled to the processor 810.

The computer-readable medium and/or memory 820 may be any recordable medium (e.g., RAM, ROM, removable memory, CD-ROM, hard drives, DVD, floppy disks or memory cards) or may be a transmission medium utilizing one or more of radio frequency (RF) coupling, Bluetooth coupling, infrared coupling etc. Any medium known or developed that can store and/or transmit information suitable for use with a computer system may be used as the computer-readable medium and/or memory 820.

The operation acts may include controlling the rendering device 830 to render elements in a form of a UI and/or controlling the rendering device 830 to render other information in accordance with the present system.

While not shown for purposes of simplifying the following description, it is readily appreciated that the content server 880 may include processors, memories, displays and user inputs similar as shown for the user device 890, as well as other networked servers, such as may host web sites, data services, etc. Accordingly, while the description contained herein focuses on details of interaction within components of the user device 890, it should be understood to similarly apply to interactions of components of the content server 880.

The processor 810 is capable of providing control signals and/or performing operations in response to input signals from the user input device 870 and executing instructions stored in the memory 820. The processor 810 may be an application-specific or general-use integrated circuit(s). Further, the processor 810 may be a dedicated processor for performing in accordance with the present system or may be a general-purpose processor wherein only one of many functions operates for performing in accordance with the present system. The processor 810 may operate utilizing a program portion, multiple program segments, or may be a hardware device utilizing a dedicated or multi-purpose integrated circuit.

Finally, the above discussion is intended to be merely illustrative of the present system and should not be construed as limiting the appended claims to any particular embodiment or group of embodiments. A further embodiment of the present system, may provide a user interface that operates as a browser extension, such as a browser rendered on the user device 890.

Thus, while the present system has been described with reference to exemplary embodiments, including user interfaces, it should also be appreciated that numerous modifications and alternative embodiments may be devised by those having ordinary skill in the art without departing from the broader and intended spirit and scope of the present system as set forth in the claims that follow. Further, while exemplary user interfaces are provided to facilitate an understanding of the present system, other user interfaces may be provided and/or elements of one user interface may be combined with another of the user interfaces in accordance with further embodiments of the present system.

The section headings included herein are intended to facilitate a review but are not intended to limit the scope of the present system. Accordingly, the specification and drawings are to be regarded in an illustrative manner and are not intended to limit the scope of the appended claims.

In interpreting the appended claims, it should be understood that:

a) the word “comprising” does not exclude the presence of other elements or acts than those listed in a given claim;

b) the word “a” or “an” preceding an element does not exclude the presence of a plurality of such elements;

c) any reference signs in the claims do not limit their scope;

d) several “means” may be represented by the same item or hardware or software implemented structure or function;

e) any of the disclosed elements may be comprised of hardware portions (e.g., including discrete and integrated electronic circuitry), software portions (e.g., computer programming), and any combination thereof;

f) hardware portions may be comprised of one or both of analog and digital portions;

g) any of the disclosed devices or portions thereof may be combined together or separated into further portions unless specifically stated otherwise;

h) no specific sequence of acts or steps is intended to be required unless specifically indicated; and

i) the term “plurality of” an element includes two or more of the claimed element, and does not imply any particular range of number of elements; that is, a plurality of elements may be as few as two elements, and may include an immeasurable number of elements.

What is claimed is:

1. A method for accessing dynamic contact data, comprising acts of:
associating a telephone number with one or more uniform resource locators (URLs) identifying corresponding data sources;
submitting a query in a form of a telephone number;
retrieving the associated one or more URLs;
retrieving data from the data sources corresponding to the one or more URLs; and
rendering the retrieved data.

2. The method of claim 1, wherein the act of associating is performed by a publisher interacting with a service platform server.

3. The method of claim 1, wherein one or more of the acts of submitting, retrieving and rendering are performed by a customer interacting with a service platform server.

4. The method of claim 1, wherein the act of submitting the query comprises acts of:
querying a contact list; and
retrieving one or more telephone numbers from the contact list, wherein the retrieved one or more telephone numbers is the submitted query.

5. The method of claim 1, wherein the act of submitting the query comprises acts of:
receiving a telephone call on a user device; and
retrieving a caller id associated with the telephone call, wherein the retrieved caller id is the submitted query.

6. The method of claim 1, wherein the acts of submitting the query and retrieving are performed periodically without further user intervention.

7. The method of claim 1, wherein the acts of submitting the query and retrieving are performed in response to starting an application on a user device without further user intervention.

8. The method of claim 1, comprising an act of associating the telephone number with an additional URL identifying an additional data source.

9. The method of claim 1, wherein the act of associating comprises an act of verifying that the telephone number is a telephone number of a user performing the act of associating.

10. The method of claim 1, wherein the act of associating comprises an act of verifying that the one or more URLs correspond to a valid data source.

11. The method of claim 1, wherein at least one of the one or more URLs correspond to an aggregator data source.

12. A computer program stored on a computer readable memory medium, the computer program configured for accessing dynamic contact data, the computer program comprising:
a program portion configured to submit a query in a form of a telephone number;
a program portion configured to retrieve one or more uniform resource locators (URLs) identifying corresponding data sources based on the telephone number;
a program portion configured to retrieve data from the data sources corresponding to the one or more URLs; and
a program portion configured to render the retrieved data.

13. The computer program of claim 12, wherein the program portion configured to submit the query is configured to query a contact list and to retrieve one or more telephone numbers from the contact list, wherein the retrieved one or more telephone numbers is the submitted query.

14. The computer program of claim 12, wherein the program portion configured to submit the query is configured to receive a telephone call on a user device and to retrieve a caller id associated with the telephone call, wherein the retrieved caller id is the submitted query.

15. The computer program of claim 12, wherein the program portion configured to submit the query, retrieve the associated one or more URLs, and retrieve the data are configured to perform those acts periodically without further user intervention.

16. The computer program of claim 12, wherein the program portion configured to submit the query, retrieve the associated one or more URLs, and retrieve the data are configured to perform those acts in response to starting an application on a user device without further user intervention.

17. The computer program of claim 12, comprising a program portion configured to associate the telephone number with the one or more URLs identifying the corresponding data sources.

18. The computer program of claim 17, wherein the program portion configured to associate comprises a program portion configured to verify that the telephone number is a telephone number of a user performing the act of associating.

19. The computer program of claim 17, wherein the program portion configured to associate comprises a program portion configured to verify that the one or more URLs correspond to a valid data source.
